(19) United States
(12) Patent Application Publication
(10) Pub. No.: US 2015/0087733 A1
(43) Pub. Date: Mar. 26, 2015

(54) Method for the Manufacture of Foams of Low Density

(71) Applicant: Rolf Heusser, Winterthur (CH)

(72) Inventor: Rolf Heusser, Winterthur (CH)

(21) Appl. No.: 14/472,539

(22) Filed: Aug. 29, 2014

(30) Foreign Application Priority Data
Sep. 20, 2013 (EP) 13185466.3
Oct. 20, 2013 (EP) 13193728.6

(51) Int. Cl. C08J 9/04

(52) U.S. Cl. CPC C08J 9/04; C08J 2300/00
USPC 521/79

(57) ABSTRACT

A method for manufacturing low density foams comprises the following steps. A polymeric material is melted in a first extruder (201) to a polymer melt, a blowing agent is added to the polymer melt, and a melt containing the blowing agent is obtained which is directed to a second extruder (211). Thereafter the melt containing the blowing agent is cooled in the second extruder (211), thereafter the melt is directed through a static mixer after leaving the second extruder (211), whereby the static mixer is disposed with a mixer insert (3), by which the temperature of the melt is homogenized over the entire cross-section, whereby the static mixer can be cooled and/or heated to obtain a temperature stabilized cooled melt. Subsequently the temperature stabilized cooled melt is discharged through a die element (240, 250).

The invention relates to a method for the manufacture of foams of low density from plastics material. Such plastic foams of low density are plastic foams of a density of less than 500 kg/m³. The plastic material is melted in a first extruder, additionally a blowing agent is added to the melted plastic material mass, thereafter the blowing agent is dissolved by mixing and dispersing processes in the first extruder and/or in a static mixing line arranged between the first and second extruder or in the second extruder, thereafter the melted mass containing the blowing agent is cooled in the second extruder, thereafter the melted mass containing the blowing agent is guided through a static mixer insert, by which the temperature of the melted mass is homogenized over the entire cross section and which can be cooled and heated at the same time so to obtain an exact melting temperature. Thereafter the cooled melted mass stabilized in temperature is discharged over a die and foams to an extrudate, thereafter the foamed or foaming extrudate is cooled until its solidification. The die can be configured as a granulator, in particular an underwater granulator. In this case the melted mass containing the blowing agent solidifies without foaming. The foaming occurs in a subsequent process.

Methods for manufacturing foams of low density are known, in which the plastic granulate is molten in a first stage of a first extruder. A gaseous or liquid blowing agent is added to and dissolved in the melted mass formed in a second stage of the first extruder. Subsequently the melt containing the blowing agent is directed by a transfer conduit into a second extruder, whereby the melt is cooled in this second extruder. The melt leaving the second extruder is guided through a static mixer. Such a static mixer can be configured as a tube shaped hollow body, in the interior of which are arranged fixed inserts which are configured as mixer inserts. The tube shaped hollow body has usually a circular shaped cross-section. The flow is disturbed by the mixer insert, whereby a thorough mixing is obtained. Habitually the melt enters the static mixer with a temperature gradient. The core temperature of the melt doesn't correspond to the wall temperature at the inner wall of the tube-shaped hollow body. By the mixing effects inside the static mixer, the temperature of the melt is homogenized over the entire cross-section. Thereafter the melt is discharged by the die and foams. Thereafter the foamed or foamable extrudate is further cooled until its solidification.

Methods are known from the document EP2138294 A1 which comprise a first extruder, a second extruder and a transfer conduit connecting the first and second extruder. The transfer conduit forms the connecting piece between the first and second extruder. A blowing agent is added to the melt after leaving the first extruder and is mixed into the melt by static mixers.

It is also known to integrate static and dynamic coolers into the transfer conduit between the first and the second extruder, to enhance the cooling power of the second extruder. Furthermore it is known to insert static mixers into the transfer conduit. From the document JP06-270232 also a heated distribution element for a foamable polymer melt is known, which is arranged downstream of a second extruder. This distribution element is a cylinder which contains a cylinder jacket with a plurality of openings. The cylinder is disposed with a wall which blocks the flow and directs it towards the cylinder jacket. The cylinder is arranged in the main direction of fluid flow. The polymer melt enters the cylinder, impinges onto the wall arranged in the cylinder and is redirected into the direction of the cylinder jacket. The foamable polymer melt is redirected about an angle of 90 degrees with respect to the main direction of fluid flow and is guided through bores from the inside to the outside of the cylinder jacket. The cylinder is surrounded by a housing, such that the melt flows in the interior of the housing until it reaches the opposite side of the wall to enter through the openings in the cylinder jacket into the cylinder again. The polymer melt is thus redirected, is pressed through the openings in the first half portion of the cylinder jacket is redirected again by the housing wall and reintroduced through the openings in the second half portion of the cylinder jacket into the cylinder inner space. That means the polymer melt is pressed through a sieve type insert, which is formed by each of the half portions of the cylinder jacket with their openings, whereby a mixing effect may evolve. The temperature differences in the melt can't be equalized by this mixing effect in any way, due to the fact that the mixing doesn't extend over the entire flow cross-section. It has to be taken into account that polymer melts flow in a laminar flow pattern and a mixing effect can only be obtained by a layer formation (caused by the deflection of a portion of the melt) but not by vortex generation. The heating elements arranged in the housing of the distribution element of JP06-270232 are used for tempering of the housing to avoid the formation of deposits or to melt the polymeric material present in the apparatus during the start-up phase of the plant. The sieve type insert is thus unsuitable for the homogenization of the temperature and also for the cooling or heating of the melt.

From the document EP0291179 it is known to control the pressure drop of a mixer for a polymer melt impregnated with a blowing agent. The mixer is arranged prior to the discharge die and is used to mix the polymer melt with the blowing agent. The control is however used to manufacture a foamed article with a good surface quality, that means a surface without holes, cracks or structures so that a gas development at the die is avoided. The quality of the foam in the interior of the foamed article is not discussed. Consequently any type of mixer can be used, in addition an extruder can be used as a mixer. That means the quality of the foam according to the findings of EP0291179 is not or only insubstantially determined by the configuration of the static mixer. Therefore the choice of the static mixer or the tempering thereof is not a point of consideration in the disclosure of EP0291179.

From the document U.S. Pat. No. 5,475,035 it is known to manufacture a foamable polymer melt by addition of two different blowing agents. Hereby the goal is to add a blowing agent containing corrosive components to the polymer melt at the latest possible moment to avoid a contamination of the extruder or the mixer. Therefore a dynamic mixer for the addition of the second blowing agent is foreseen to complete the mixing of a blowing agent containing corrosive components into the polymer melt as fast as possible. Consequently a temperature equalization is not foreseen for improving the surface quality of the foamed extrudate according to the method described in U.S. Pat. No. 5,475,035. The use of a dynamic mixer corresponds also to the predominant expert opinion that the use of dynamic coolers for a precooled polymer melt in a cooling extruder is more suitable. The melt is in such a method close to the solidification point. Therefore it has been contemplated when applying the methods according to EP0291179 or U.S. Pat. No. 5,475,035, that with the use of static mixers deposits and a freezing of the melt results. In particular this effect is promoted by a cooling of a static mixer.

It has been shown that with the known methods, a satisfactory constant foam quality can't be obtained all the time. Under a good foam quality foam products are intended which are characterized by example by high mechanical tear and pressure resistances, low densities or high insulating values. These values are influenced by the cell structure of the foam product. A narrow cell size distribution, as many small cell sizes and as many cells per volume unit with as thin cell walls as possible are often important for good foam qualities. The cell structures obtained should be as regular as possible over the time period as well as in the entire product cross-section.

A large number of static mixers is known, however these static mixers have a number of disadvantages, such that a satisfactory foam quality is not obtainable by their use. For instance in the EP 0980703 A1 a static mixer is proposed which is disposed with channels for a heat exchange fluid. This static mixer is disposed with plate elements arranged in the direction of flow, which are arranged crosswise to each other. The plate elements are named webs. These webs extend over the entire width of the mixing element. The webs are configured as thick-walled plate elements as they contain a channel which passes transversely to the main direction of fluid flow through each of the webs. The jagged webs induce transverse mixing only to a small extent and only locally, thus not covering the entire cross-section of the mixing space. The fluid flow impinging onto the web is separated by each web into two main partial flows passing laterally of the web and into two auxiliary partial flows of the fluid stream which is deflected along the spikes of the web from the spike peak to the neighboring spike valley. The deflection of the auxiliary partial flow is effected from each of the spike peaks, such that a partial deflection of the auxiliary part stream can be carried out. However, this deflection remains limited to the small auxiliary partial flow and only to a portion of the cross-section of the mixer, as each web comprises a multitude of spikes. Therefore the fraction of transversal mixing is small in the mixer shown in EP 0980703 A1.

A variant of such a static mixer is shown in the EP 1 384 502 A1. In the same manner as in EP 0980703 A1 the channels for a heat exchange fluid run transversal to the main direction of fluid flow. The channels of EP 1 384 502 A1 run inside ribbed tubes. The ribs can extend for example in a star shaped manner into the fluid flow. These ribs only allow for a small deflection or lateral translation of the fluid stream, which is also limited locally to the environment of the ribs. As no heat exchange fluid flows through the ribs, they have only limited efficiency as heat exchange surface. On the other hand they require a relatively large amount of space. Therefore a denser packing of tubes through which a heat exchange fluid passes through can't be realized and consequently the obtainable heat exchange surface is reduced.

The document U.S. Pat. No. 4,865,460 A shows a static mixer with tubular mixer inserts. However the tubes with circular cross-section shown in this document have the inherent disadvantage that the mixing capacity is not optimal due to the small flow resistance of the tubes arranged in this flow. Therefore the solution according to U.S. Pat. No. 4,865,460 A has proved to achieve a heat exchange from the tubes to the material flowing in the conduit, however due to the geometrical limitation of the cylinder geometry a limited mixing capacity is delivered, which does not cover the entire mixing space, which is named a conduit in this document. The document EP 1 123 730 A2 also shows a static mixer, which contains tubes a mixing elements. The tubes are arranged in grids which are rotated about the central axis of the mixing element. Three or four grids are used, which are arranged in an angle of 120 degrees, respectively 90 degrees with respect to each other. The mixer is not used for highly viscous polymer melt, due to the fact that the grid structure arranged loosely in a housing is not suitable for processing of highly viscous polymer melts. In the inventive method, the static mixers used have to withstand usually nominal pressures of about 200 bar and temperatures of about 250 degrees Celsius.

It is an object of the invention to optimize the method for manufacturing a low density foam to obtain a constant foam quality that is in particular a foam with homogeneous physical properties which results in improved mechanical properties, such as strength, ductility or form stability and/or increased heat insulation values or decreased foam density.

Therefore a method for manufacturing low density foams is proposed, in which a polymeric material is melted in a first extruder to a polymer melt, the polymer melt is fed to a second extruder, a blowing agent is added to the polymer melt, such that a melt containing the blowing agent is obtained, thereafter the melt containing the blowing agent is cooled in the second extruder, thereafter the melt is directed through a static mixer after leaving the second extruder, whereby the static mixer is disposed with a mixer insert, whereby the mixer insert has insert elements, which engage with the melt, such that the temperature of the melt is homogenized over the entire cross-section of the mixer insert, whereby the static mixer can be cooled and/or heated to obtain a temperature stabilized cooled melt, subsequently the temperature stabilized melt is discharged through a die. By the expression of a temperature stabilized melt, a melt is intended which has a uniform temperature which is measured over the melt cross-section. At least one of the insert elements can contain a channel for the passage of a heat exchange fluid. The blowing agent can be added to the polymer melt in the first extruder and/or in the second extruder and/or in the transfer conduit between the first and second extruder.

The blowing agent can be dissolved in the melt by mixing or dispersion processes in the first extruder and/or a static mixer and/or a transfer conduit between the first and the second extruder and/or in the second extruder.

It has been shown that for reaching a good foam quality an exact temperature control is necessary in addition to the homogenization of the temperature in the melt upstream of the die, moreover the melt temperature, thus the temperature of the melt for obtaining very low foam densities has to be kept very low. The inhomogeneous temperature distribution present after the second extruder can be equalized by prior art static mixers arranged downstream of the second extruder. The static mixers are not suitable for setting the temperature due to the fact that no efficient cooling or heating thereof is possible. In addition the use of static mixers causes in many cases a temperature increase of the melt due to the pressure drop in the mixer. The back pressure thereby acts onto the second extruder and is compensated accordingly by an increased friction in the extruder. Friction leads to the generation of heat, which causes a temperature rise of the melt. A temperature rise of the melt is in many cases undesirable due to the fact that low foam densities can't be obtained thereby. Under a foam of low foam density it is to be understood a foam of a density of less than 50%, advantageously less than 20%, particularly preferred less than 10% compared to the density of an unfoamed polymer melt.

An exact temperature control at the discharge end of the second extruder is often very difficult due to the fact that the melt has to be cooled in the second extruder by highly pushing temperature differences of usually 20 up to more than 80 degrees Celsius. Accordingly a control of the exit temperature in the range of plus/minus 1 to 4 degrees Celsius is very difficult. In addition it has to be taken into account that the melting temperature at the discharge end of the second extruder is rather inhomogeneous across the cross-section. The temperature difference between a zone of the polymer melt close to the wall and a central zone can be up to 30° C. Under a central zone there is intended a zone which corresponds to a rotational symmetric body which is arranged around the central axis of the extruder and extends up to a third of the distance between the middle axis and the inner wall of the extruder or the static mixer.

In addition changes of the process for example the formation of deposits in the second extruder or a change of quality of the used polymer raw material can lead to periodical changes of the temperature profile. The temperature differences caused by the static mixers as well as the periodical temperature differences due to the process can't be compensated anymore by the methods according to the prior art and lead to bad or changing foam qualities.

The optimization of the method according to the invention is such that the melt is directed through a static mixer insert subsequent to the second extruder, by which it can be cooled and heated at the same time. The term melt stream can be used as a synonym for the term melt. The temperature is equalized over the entire cross-section by the mixer insert downstream of the second extruder. The mixer insert is disposed with inserts which extend into the melt. Additionally the melt can be cooled or heated by the inserts. A homogeneous melt temperature can be reached, which means that the coldest, lowest temperature and the hottest, highest temperature differ from each other by less than 5 degrees, preferably less than 3 degrees, particularly preferred less than 1.5 degrees in the melt cross-section downstream of the mixer insert. The static mixer insert can be cooled or heated contemporaneously by a heat exchange medium to bring the melt to an optimal processing temperature. The tempering can be obtained for example from the exterior by a double jacket which is filled by a flowing heat exchange medium. Liquids such as water or oils are suitable as a heat exchange medium. Other liquids or gases such as air can be used. It has been shown that in particular for higher melt through-puts of at least 50 kg/h a tempering from the exterior only has limited effect, due to the fact that the tempering surface is too small compared to the mixer volume. For a higher melt through put, the heat exchange medium is directed advantageously over inserts which extend into the melt flow to increase the tempering surface. The mixer insert and the insert for the heat exchange medium are arranged advantageously in such a manner that the melt is not divided into partial flows, but is mixed as a whole continuously over the entire cross-section. The mixer insert can comprise insert elements of any shape. The insert elements can comprise tubular, web-shaped or substantially two-dimensional, for instance wing-shaped web elements.

Advantageously a temperature equalization or a pre-cooling of the melt can already occur already between the first and second extruder, whereby the melt is directed over a dynamic mixer, a static mixer, a heat exchanger or a transfer conduit, which can be configured in particular as a heated or cooled tubular element or a combination of at least two of the aforementioned devices.

At least a portion of the web elements can form a group. Such a group can be formed for example in such a way that the web elements each have a central axis. The central axes of the web elements belonging to the group enclose a substantially constant angle with respect to the central axis of the mixer insert.

It has been shown that a mixer insert is particularly well suited, which comprises a first group of web elements and a second group of web elements, whereby the first group of web elements extends along a common first group plane and the second group of web elements extends along a second common group plane. Such mixer inserts can balance the temperature particularly well over the entire cross-section. Insert elements of any shape can be used as engaging insert elements for the tempering of the melt, for example web elements containing tubes or channels which are arranged parallel to the main direction of melt flow or also insert elements which are arranged in an angle to the melt flow. The angle between the central axis of the mixer insert and the central axis of the insert element can be configured as an acute angle or a complimentary obtuse angle. The central axis of the mixer insert corresponds to the main direction of fluid flow of the melt flow. Under engaging insert elements, insert elements are intended which extend into the melt. Such an insert element is thus a flow disturbing body which forces the melt to change direction locally.

One or more groups of web elements can be connected to the cladding element of the housing or can be arranged as a dismountable mixer insert in the housing. It has been shown that it is particularly advantageous to combine the engaging insert elements for the melt tempering with the insert elements arranged in the mixer insert. Thus two groups of intersecting web elements or tubular elements can be used through which a heat exchange medium flows. The intersecting web element groups or tubular element groups are attached to a head plate and can be disassembled from the mixer tube enclosing them. Large heat exchange surfaces can be realized with such mixer inserts. At least a portion of the web elements can contain channels, whereby the channels extend from a first end of the web element to a second end of the web element, whereby the cladding element contains a corresponding channel to each web element, which is in fluidic connection with the first end and the second end of the web element.

The mixer inserts can be composed of a plurality of tubular elements which extend from a feed end of the mixer to a discharge end thereof. The beginning and the end of the tubular element of the mixer insert can be arranged in the same head plate. This head plate is connected with the mixer, in particular with the housing enclosing the mixer insert. Such a tubular element comprises at least a deviation, which can be for example u-shaped. The tubular element can comprise further deviations in addition to this deviation. In particular such a tubular element can be configured such that the deviations are arranged in the vicinity of the wall and straight tube pieces extend between neighboring deviations. The straight tube pieces can extend in an acute angle with respect to the central axis of the mixer, the angle can in particular be between 10° and 80°. A plurality of such tubular elements can form a tube bundle. The tube bundle can contain a plurality of groups of tubular elements whereby the tubular elements of the same group are arranged substantially parallel to each other. The group plane runs through the central axes of the tubular elements or web elements belonging to the corresponding group.

It has been shown that the mixing effect of such a tube bundle which is used predominantly as a heat exchanger doesn't lead under certain circumstances to optimal results, due to the fact that the expanding tubes in the boundary region have a negative influence onto the mixing effect. Such a heat exchanger is shown for instance in the document DE2839564. Under boundary region it is intended the portion of the mixer insert near to the wall, that means the portion of the mixer insert which is situated most closely to the enveloping mixer housing. An expansion of the tubes is a consequence of the temperatures present in the polymer melt, which can amount up to 250° C. depending on the composition of the polymer melt.

Insert elements are particularly suitable in which the static mixer insert comprises a first group of web elements and a second group of web elements, whereby the first group of web elements extends along a first common group plane and the second group of web elements extends along a second common group plane. At least a portion of the web elements contains channels, whereby the channels extend from a first end of the web element to a second end of the web element. The cladding element contains a corresponding channel, which is in fluidic connection with the first end and the second end of the web element. The cladding element contains a corresponding channel, which is in fluidic connection with the first end and the second end of the web element. Such tempered mixer inserts are characterized by a very good mixing effect and at the same time a very high cooling or heating power. As the mixer insert is also used for tempering, no additional inserts are required, such as tubes arranged parallel to the melt flow to be used for tempering but disturbing the mixing process.

It has been shown that by using the inventive mixer insert in combination with the described method, in a lot of cases a surprising improvement of the foam structure is obtained. Special foams with very homogeneous cell structures, low foam density and narrow cell size distribution can be obtained. Due to the outstanding cell structure, the physical properties such as tear resistance, tensile strength or insulation values are very good. A set foam structure can be maintained over time constantly, due to the fact that differing temperature conditions can be equalized by the extruder.

It has been further shown, that it is very advantageous to control the melt temperature for a cooling and heating mixer insert. Advantageously, the melt temperature is measured downstream of the mixer insert, for example in the discharge region of the mixer insert or in the die and is kept by cooling or heating of the mixer insert at an adjustable set temperature. Thereby a given temperature can be maintained also during variable process conditions, which is important for maintaining a constant foam quality.

A substantially homogeneous temperature distribution over the cross section of the melt has the advantage that the cell size distribution is equalized over the entire cross section of the extrudate. Due to the small variation of cell size in the cross-section a homogeneous cell configuration is obtained, which leads to a polymeric body with a defined profile of properties. In particular the mean cell size of a lateral section comprising 20% of the entire width of the extruded foil or plate differs less than 20%, advantageously less than 10% from the mean cell sizes of any further lateral sections.

For the manufacture of plates and foils for thermal insulation, the portion of open cells is in particular less than 15%, advantageously less than 10%, particularly advantageously less than 5% of the entire amount of cells.

The inventive method can be used for the manufacture of low polystyrene, polypropylene, polyethylene, polyethyleneterephthalate, polyvinylchloride, polyacrylnitrile, polyamide, polyester, polyacrylate, polylactic acid (PLA) and other biopolymers or mixtures thereof. Any liquids, gases or solids which emit gases can be used as blowing agents or mixtures of blowing agents. Ethers, hydrocarbons, ketones, esters, water, carbon dioxide or nitrogen are particularly suitable as blowing agents. The discharge element downstream of the mixer insert can comprise a die or a granulator. Instead of the use of a die, in which the extrudate foams, a granulator, in particular an underwater granulator, can be used to granulate the melt containing the blowing agent, whereby the melt foams in a subsequent process step.

A device for static mixing and heat exchange comprises a cladding element and a mixer insert, whereby the mixer insert is in the operative state arranged inside the cladding element. The mixer insert has a longitudinal axis, which extends substantially in the direction of flow of the flowable medium.

The mixer insert comprises a first group of web elements as well as a second group of web elements, whereby the first group of web elements extends along a common first group plane and the second group of web elements extends along a second common group plane. The group plane is characterized in that it contains the central axis of the web elements. At least a portion of the web elements is disposed with channels, whereby the channels extend from a first end of the web element to the second end of the web element.

The cladding element contains a corresponding channel, which is in fluid connection with the first end and the second end of the web element, whereby the transition from at least one of the first and second ends of the web element to the corresponding channel in the cladding element is free from any gap. At least a portion of the web elements extends therefore over the entire lateral dimension or the diameter of the cladding element. The channels in the web elements extend from the first end of the web element to the second end of the web element which connects directly to the inner wall of the cladding element. Inside the cladding element, there is located a channel, which connects to the end portion of the channel to the corresponding end portion of the web element. The web elements can therefore be fed from the cladding element with a heat exchange fluid, in particular a heat exchange liquid, and the heat exchange fluid flows through the web elements. The length of the channel is greater than the mean diameter of the cladding element, if the web element comprises the longitudinal axis. The average diameter corresponds to the inner diameter, if the cladding element is configured as a circular tube. The mean diameter for an edged cladding element is defined as its circumference/π, thus it is an equivalent diameter. The length of the channel is at least 10% above the mean diameter if the channel crosses the central axis. The length of this channel lies in particular at least 20% above the mean diameter, particularly preferred at least 30% above the mean diameter.

A web element is characterized by its dimensions, thus its length, its width and its thickness. The length of the web element is measured from the first end of the web element to the second end of the web element. The length of the channel corresponds substantially to the length of the web element.

The width of the web element is measured substantially laterally to the direction of flow. That means that the width extends substantially in a plane which is arranged normally to the length of the web element and shows the cross-section of the web element. The cross-section of the web element is characterized by its width and its thickness. The length of at least the longest web elements of a group of web elements is at least 5 times as long as its width.

The width of the web element is 0.5 to 5 times as large as its thickness, advantageously 0.75 to 3 times as large as its thickness. If the width of the web element is once or twice the thickness, a particularly preferred range is obtained, which provides a particularly good transversal mixing. The width of the web element is defined as the normal distance between the first edge and the second edge of the web element viewed from the upstream side. The width of the web element on the upstream side can differ from the width of the web element measured on the downstream side.

Under the edge is intended the edge of the web element onto which the flow impinges upon and passes by, said edge extends substantially parallel to the length of the web element. The thickness of the web element can be variable. The minimal thickness is less than 75% advantageously less than 50% of the maximal thickness. The variations can be caused by ribs, by indentations, by protrusions or by wedge-shaped web elements or another unevenness.

A web element is characterized in that planar surfaces or concave surfaces are present in the direction of flow, which offer an impact surface for the flowing fluid. These surfaces arranged in the direction of flow have the effect of a higher resistance of the downstream flow. It has been shown that a tube element has a small mixing effect. A tube element has been described as a solution in the document DE 68 905 806 T2. The tube element has a noteworthy worse mixing effect compared to web elements. In addition, in document EP 1 384 502 A1 it is pointed out that round profiles arranged in the fluid flow have a small mixing effect.

The channel, which is arranged inside the web element has advantageously an inner diameter, which corresponds to a maximum of 75% of the thickness of the web element. Basically, also a plurality of channels arranged substantially parallel to each other can be arranged in a web element.

The transition from at least one of the first and second ends of the web element to the corresponding channel in the body of the cladding element is free from gaps. The web elements of the mixer insert as well as the cladding element are thus composed of a singular piece, which is advantageously manufactured by a casting method. It is a characteristic of the property of a transition, which is free from gaps, such that the transition from the web element to the cladding element occurs smoothly. In particular, the edges are rounded in the transition area between the web element and the cladding element, whereby the flow of the casting material is not hindered during the manufacturing process.

The channels are arranged inside the web elements such that there exists no connection between the channels inside the web elements and the mixing space surrounding the web elements.

During the casting method, a monolithical structure is manufactured at least in segments consisting of a first and second group of web elements arranged in an angle to the main direction of fluid flow which is not equal to zero and a cladding element which is fixed to at least a portion of the web elements, whereby the cladding element can be configured as a cladding tube.

The web elements are provided at least partly with channels which can be used by a heat exchange fluid in operative condition. The channels are in operative condition not in connection with the flowable medium, said flowable medium flows around the web elements. The channels extend from a first end of the web element to a second end of the web element. The cladding element contains at least one corresponding channel, which is in fluid connection with the first end and the second end of the web element, whereby the transition between at least one of the first and second ends of the web element to the corresponding channel in the cladding element is free from gaps. The length of the channel is greater than the mean diameter of the cladding element, if the web element contains the longitudinal axis.

The channels for the heat exchange fluid in the web elements can be manufactured by the casting method, however a subsequent reworking step can also be performed, such as eroding or boring. Surprisingly it has been shown, that the direct casting of the channels or a subsequent boring of the channels is possible in a very simple and economic manner.

During the casting method a casting mold is manufactured by means of a wax body, a ceramic shell is then applied onto the wax body, subsequently the wax is removed and the ceramic shell is burned and the burnt ceramic shell is filled with casting material. The casting material is hardened by cooling and the ceramic shell is removed after the hardening of the casting material has been completed. The device can be manufactured from any material which is suitable for being processed by a casting method, such as metal, plastic or a ceramic material. The web elements are advantageously configured as rectangles, whereby the edges may also be rounded. The edges can also assume any other cross-section, in particular a cross-section from the group of circles, ovals, rectangles with rounded edges or polygons. The cross-sectional areas can be different in each single web element or can differ between a pluralities of web elements, as an example, the thickness or the width of a web element can vary. Under a cladding element, a cladding of the mixer insert of arbitrary cross-section and geometry is to be understood, including for example also a tube or a rectangular channel.

The heat exchange fluid may comprise any liquid, such as water or oils or also any gas, such as air. The web elements are arranged advantageously in an angle of about 25 to 75 degrees and more advantageously in an angle of about 30 to 60 degrees with respect to the main direction of fluid flow.

According to an embodiment, the first and second group planes intersect. According to a further embodiment, a web element of the second group follows a web element of the first group. Neighboring web elements thus have according to this embodiment a different orientation, as they belong to different groups.

According to a preferred embodiment, neighboring web elements intersect, whereby such an arrangement enhances the mixing effect. The angle between two web elements crossing each other is advantageously 25 to 75 degrees. A group can comprise any plurality of web elements arranged next to each other. A group is characterized in that the central axes of all web elements span the same or substantially the same group plane. In particular, 2 up to and including 20 web elements are arranged in a parallel configuration in a group, particularly preferred 4 up to and including 12 web elements.

It is possible to arrange any plurality of groups of web elements behind each other, when looking in the main fluid flow direction. The groups arranged subsequently to each other are advantageously configured in a manner that they overlap to generate the largest possible active heat exchange area in a small apparatus volume. Overlapping means, that at least a portion of the web elements of to first group and a portion of the web elements of a subsequent group and/or a preceding group are arranged in the same tube section, seen in main fluid flow direction.

The projection of the length of the web element onto the longitudinal axis results in a length L1 and the projection of the overlapping part of the web elements of the neighboring group onto the longitudinal axis results in a length L2, whereby L2 is smaller than L1 and L2 is greater than 0. The tube section considered is thereby defined by having the length L1 that means that the tube section extends from the centrally arranged web element from its first end to its second end, when projected onto the longitudinal axis.

Due to the fact that the mixing effect in groups of web elements of the same orientation arranged behind another takes place only in one plane, the orientation is changed after a certain number of groups, such that the groups are advantageously arranged in a staggered manner with respect to each other.

In particular two up to and including 20 groups are foreseen, particularly preferred 4 up to and including 8 groups. The dislocation between the groups oriented in the same way is advantageously in an angle of 80 degrees to 100 degrees thus the first group is arranged transversely to the second group in an angle of 80 to 100 degrees. That means that the second group is rotated around the main axis of the mixer insert about an angle of 80 to 100 degrees with respect to the first group.

In addition to groups of crosswise arranged web elements as outlined above, groups of web elements in particular in the final section of parallel groups of web elements can be foreseen, which contain web elements which extend only from the inner wall of the cladding element to the crossing line of the other group. In the following, these groups of web elements are referred to as half crossing web element groups. These groups lead to an increase in mixing performance. Due to the better mixing effect and the additional thermal conduction of the web element material, the heat exchange is additionally increased.

The web elements of the first and second group may touch each other mutually or may contain intermediate spaces. A connection of the intermediate spaces with connection web elements arranged transversely to the main direction of fluid flow is also possible.

The heat exchange fluid is advantageously supplied over a double jacket and flows therethrough as well as through at least a portion of the crosswise arranged web elements. Thereby not only the surface of the inner wall of the cladding element, but also the surface of the heated or cooled web elements can be used as a heat exchange surface. The double jacket can be formed on the inner side by a cladding tube and on the outer side by a second outer cladding tube. The outer cladding tube contains connections for the supply and discharge of heat exchange fluid. Between the cladding tube and the outer cladding tube, vanes are advantageously arranged, which guide the heat exchange fluid in the double jacket through the web elements, whereby the apparatus is subjected mostly to an even flow. It is possible that the flow through different portions or segments of the device according to the invention is separated by double jacket segments. This allows for a different temperature regime in each of the segments. The heat exchange fluid can be supplied directly from the outside to the web elements. Thereby the use of the cladding tube as a heat exchange surface is limited. It has been shown, that for a high heat exchange rate in a small apparatus having diameters of the cladding tube of 60 mm or more, at least half of the web elements would have to be exposed to the heat exchange fluid flow.

It has been shown that it is possible to obtain a very economic casting manufacturing method for the web elements and the cladding element connected monolithically and gap-free to the web elements. Thereby the complete cladding element together with the corresponding web elements can be manufactured in one piece or a number of segments can be manufactured separately, which are subsequently connected for example by welding or by screwed flange connections. Furthermore, the external geometry of the web elements and the channel geometry for the heat exchange fluid can be easily decoupled. For the external geometry, rectangular profiles can be used advantageously and the geometry of the channel can be a round cross-section, in particular chosen from a circular or oval cross-section. Thereby web elements with an ideal profile for a transversal mixture and at the same time of a high strength can be manufactured for high maximum fluid pressures. It has been shown that the passages for the heat exchange fluid in the web elements can be manufactured advantageously after the casting process by eroding or even more advantageously by boring. Thereby even smallest channels can be manufactured.

It has been further shown, that with the inventive groups of web elements and in particular with web elements in which neighboring web elements intersect and/or in particular with overlapping groups of web elements a very good mixing performance can be obtained. A fast mixing can be particularly promoted by the arrangement of the second group, which is staggered about 80 to 100 degrees with respect to the first group. Surprisingly it has been shown that the arrangement of additional partial groups for viscous fluids in particular a further improvement of the mixing performance that means a higher mixing quality.

Due to the fact that the heat exchange fluid flows in the inner space of the double jacket and inside the web elements, the mixing performance is not decreased by additional inserts of tubes, which are used as a passage for the heat exchanging fluid. In addition, the mixing performance in the boundary region is improved by the direct transition of the web elements to the cladding element due to the fact that boundary layers of the flowable medium close to the inner wall also participate to obtain a homogeneous mixture. In particular, not only an optimal renewal of the boundary layers between the flowable material and the cladding element but also between the flowable medium and the surface of the web element can be obtained. The optimal renewal of the boundary layer also has the consequence of an optimal use of the heat exchange area. The optimal use of the heat exchange area also leads also to the construction of a device for a given heating or cooling task of a small apparatus volume with a very mall pressure drop.

Due to the optimal mixing effect, the inventive device also has a very narrow residence time distribution of the flowable medium to be heated or cooled. Thereby deposits or the decomposition of the flowable medium can be avoided in the best possible manner. A very low melting temperature close to the freezing point can be obtained for cooling tasks which concern the cooling of viscous fluids, such as for example a polymer, due to the optimal renewal of the boundary layers. Hereby it is avoided, that a hardening polymer forms a deposit on the heat exchange surfaces. The direct transition of each of the web elements to the cladding element leads to a very stable construction, which is suitable also for operation with high fluid operating pressures. Thereby the inventive device can be of a very compact construction in particular for the operation with viscous fluids. The device is principally suitable for mixing and cooling or heating of any flowable medium, such as a liquid or a gas, in particular for viscous or very viscous fluids, such as polymers.

The cladding element and the mixer insert consist in particular of castable material, for instance metals, ceramics, plastics or combinations of these materials may be used.

A blowing agent can be added by a blowing agent supply device to one of the first or second extruders or to the transfer conduit.

Subsequently the inventive method is shown in some embodiments. It is shown in

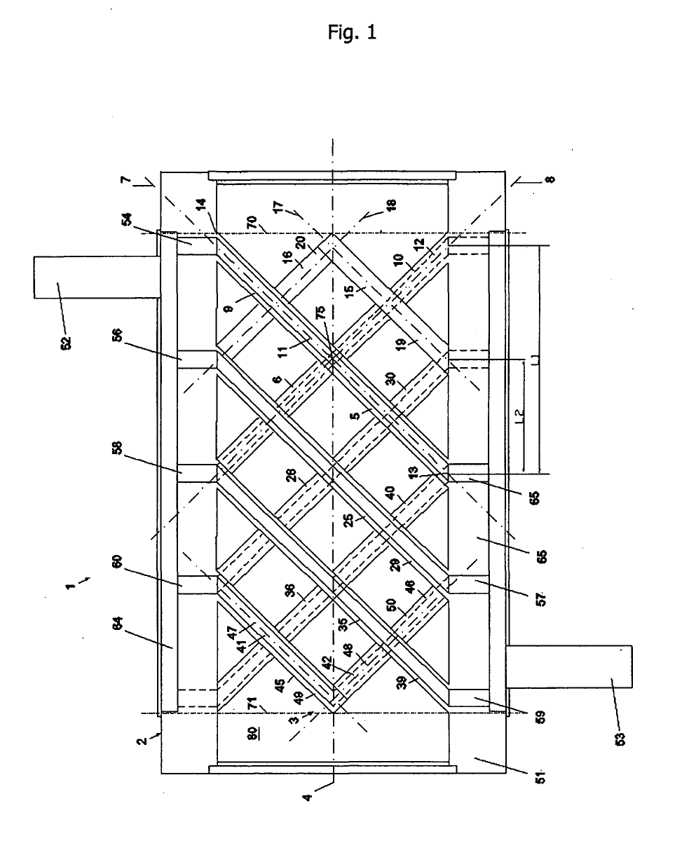

FIG. 1: a two-dimensional sectional view through a first embodiment of a mixer insert of the device according to the invention,

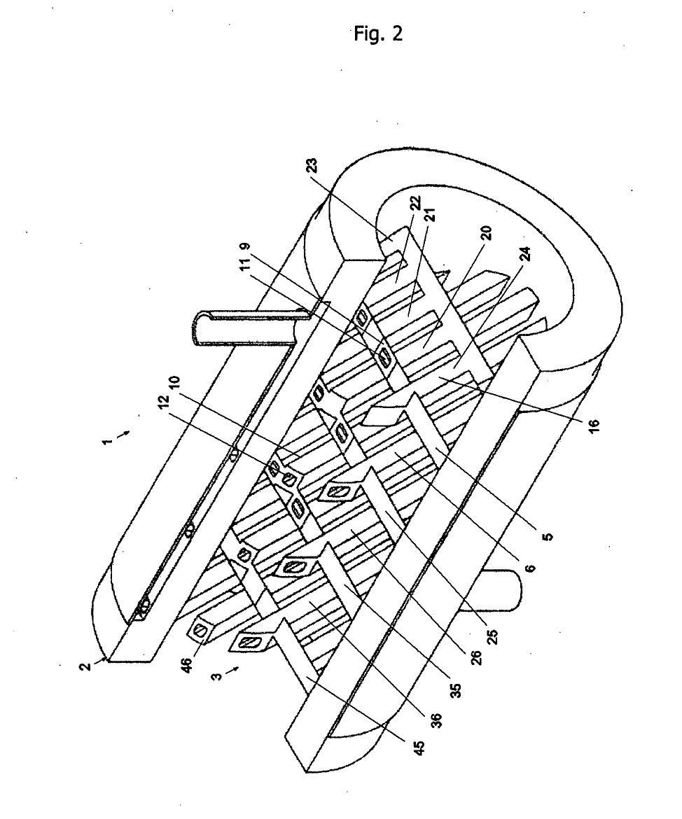

FIG. 2: three-dimensional sectional view through the device according to FIG. 1,

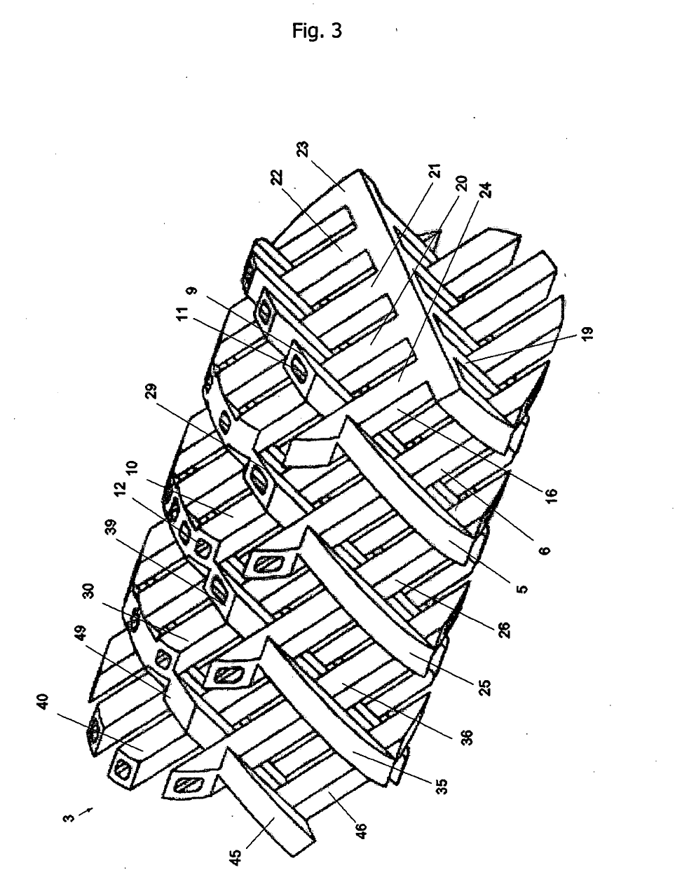

FIG. 3: a view of the mixer insert for the device according to FIG. 1,

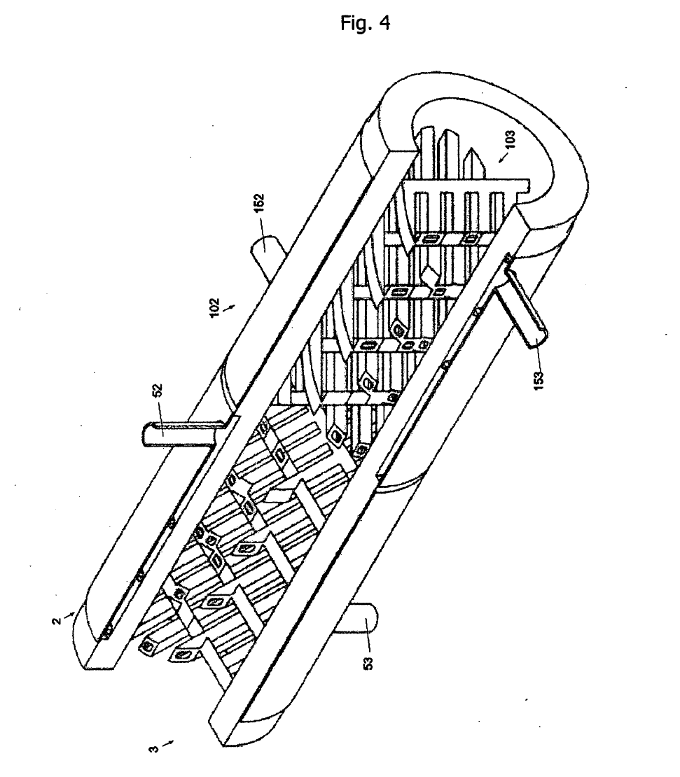

FIG. 4: three-dimensional sectional view through the device according to a second embodiment,

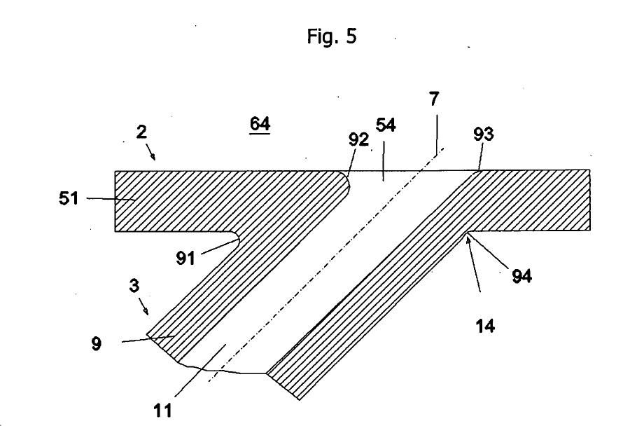

FIG. 5: a detail of the transition from a web element to a cladding element according to FIG. 1,

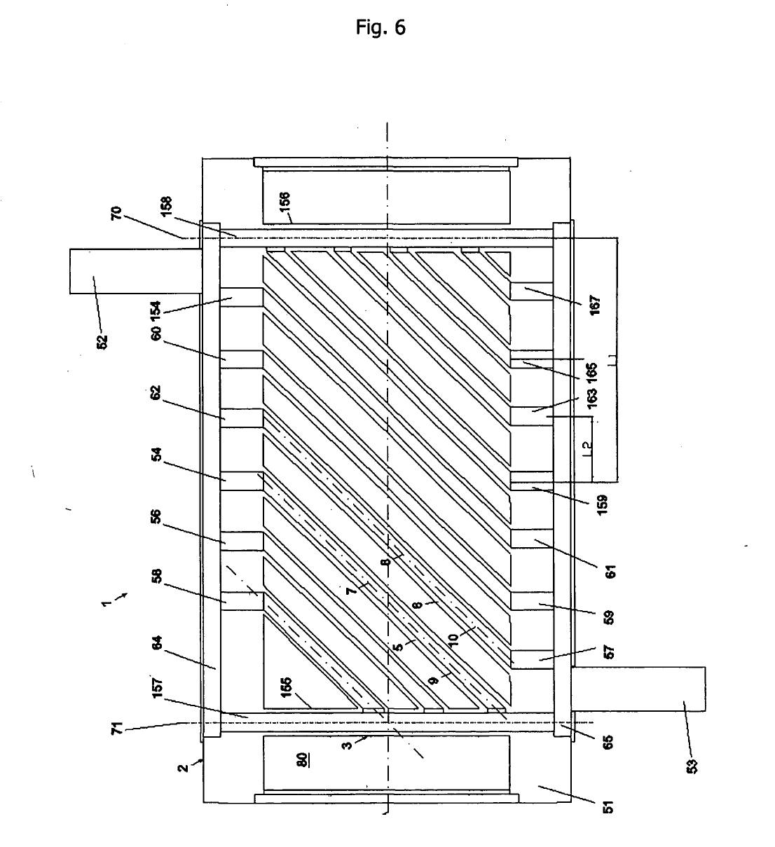

FIG. 6: a two-dimensional sectional view through the inventive device according to a third embodiment,

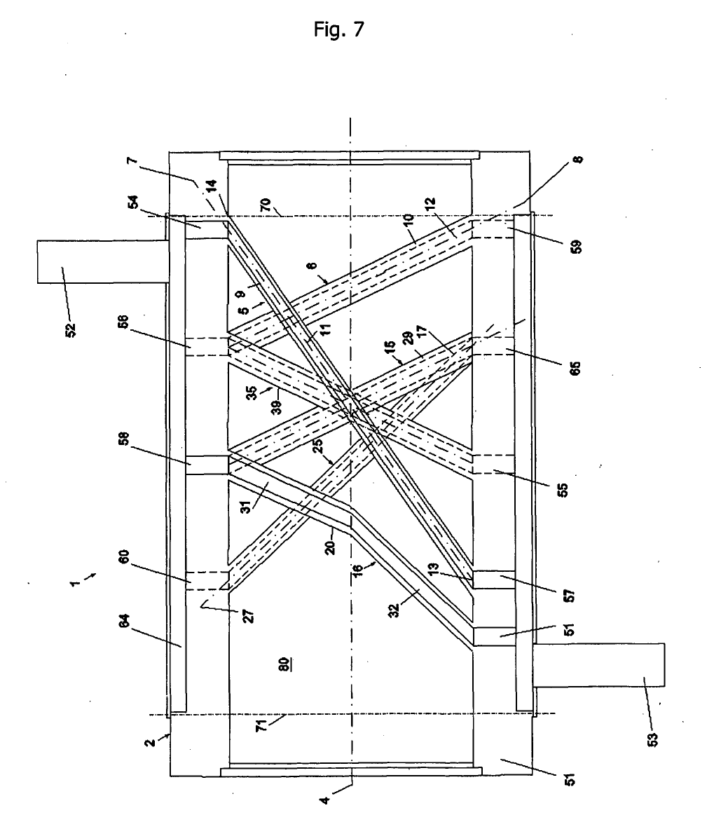

FIG. 7: a two-dimensional sectional view through the inventive device according to a fourth embodiment,

FIG. 8: a view of the mixer insert according to a fifth embodiment of the inventive device,

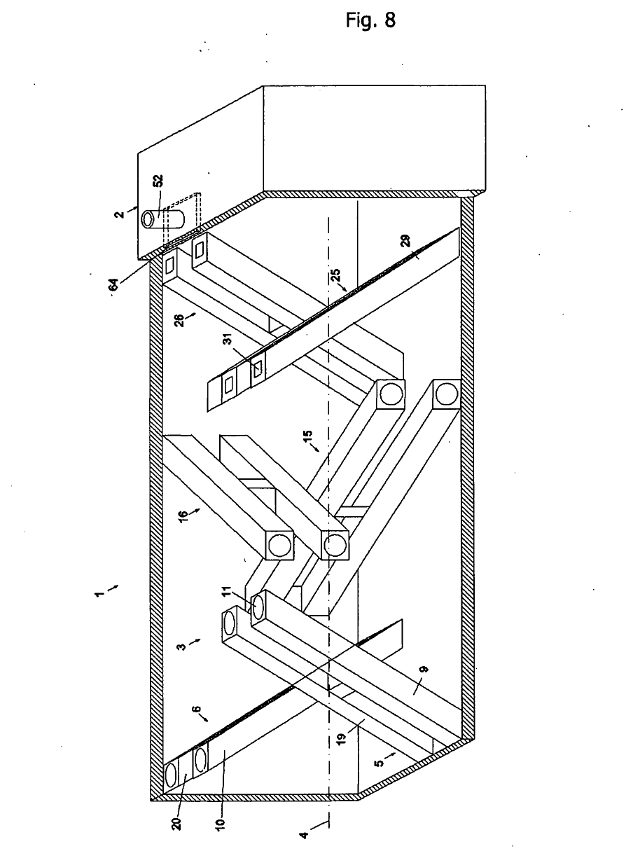

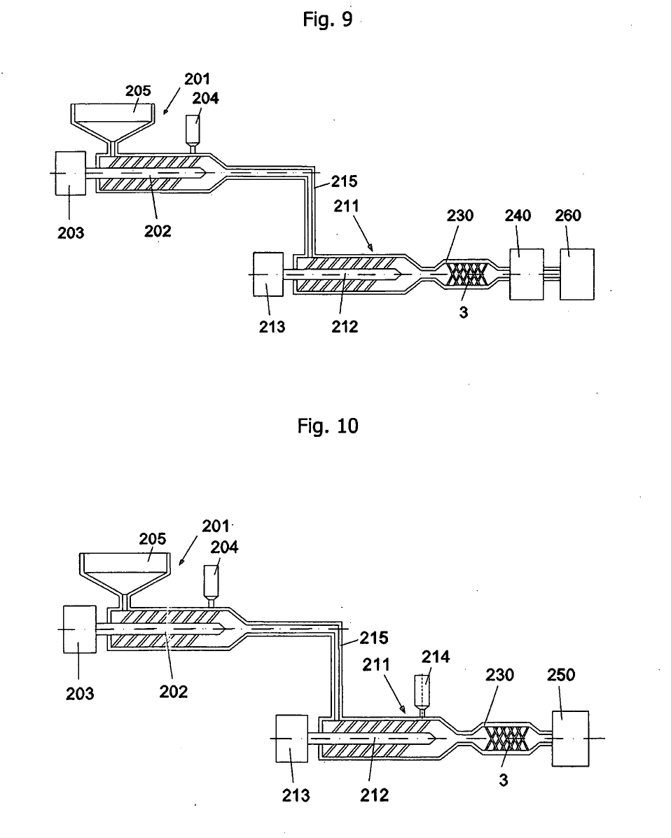

FIG. 9: a first variant of an extrusion arrangement with a mixer insert,

FIG. 10: a second variant of an extrusion arrangement with a mixer insert

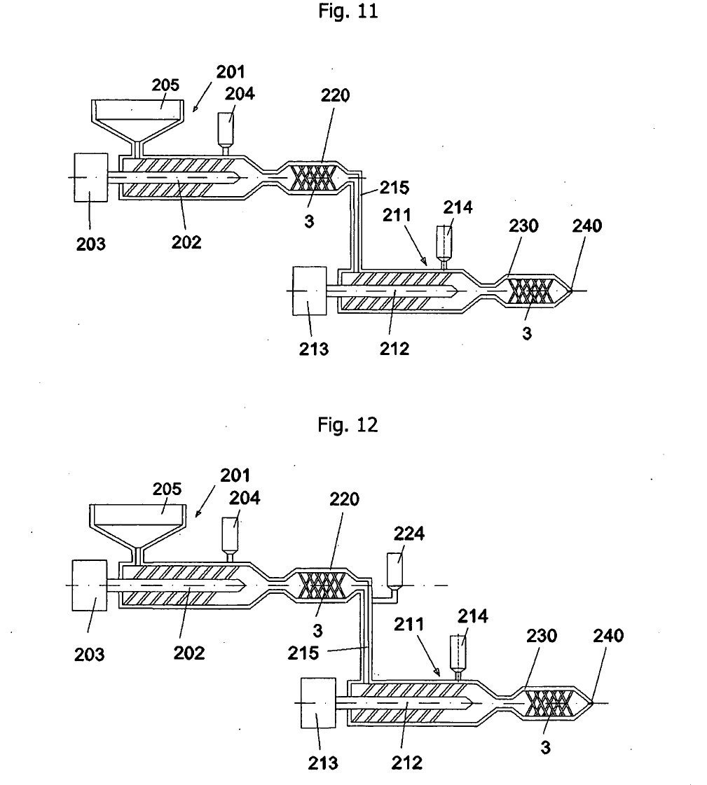

FIG. 11: a third variant of an extrusion arrangement with a mixer insert,

FIG. 12: a fourth variant of an extrusion arrangement with a mixer insert

The device 1 for static mixing and heat exchange consists of a cladding element 2 and a mixer insert 3, whereby the mixer insert 3 is arranged in the operating state inside the cladding element 2. The mixer insert 3 has a longitudinal axis 4, which extends substantially in the main direction of flow of the flowable medium, which flows through the cladding element 2 in the operating state. The mixer insert comprises a first group 5 of web elements and a second group 6 of web elements. In FIG. 1 the first group 15, the second group 16, the first group 25, the second group 26, the first group 35, the second group 36 as well as the first group 45 and the second group 46 are shown. With the exception of the group pairs 15, 16 and 45, 46 all group pairs are configured in the same manner. Therefore the subsequent description applies to the first groups 5, 25, 35 as well as the second groups 6, 26, 36. Each group can comprise a plurality of web elements. Depending on the size of the mixing space 80 and/or the width of the web elements 2 up to 20, preferably 4 up to 12 web elements of a group can be arranged parallel to each other. Under the length of a web element it is to be understood the dimension from the first end 13 to the second end 14 of the web element along its central axis. Under the thickness of a web element it is to be understood the dimension normal to the central axis from one edge to the opposite edge. Under the width of the web element it is intended its dimension crosswise to the longitudinal axis 4, thus the dimension which is arranged normally to the plane of the drawing in FIG. 1.

The first group 5 of web elements extends along a common first group plane 7. The group plane 7 contains the longitudinal axis of a channel 11 running inside the web element 9, if the channel is arranged such that its longitudinal axis coincides with the central axis of the web element. In the current graphical representation the group plane 7 is arranged normally to the plane of the drawing.

The second group 6 of web elements extends along a second common group plane 8. The group plane 8 is defined in the same manner as the group plane 7. The first and second group planes 6, 7 intersect. In this graphical representation they intersect exactly on the longitudinal axis 4 of the mixer insert. A web element 9 of the first group follows a web element 10 of the second group. The web element 9 is thus arranged crosswise to the web element 10. The web elements of the first group alternate with the web elements of the second group. The web element 9 is cut along its longitudinal axis, such that only one half of the channel 11 is visible. The web element 10 is positioned in relation to the plane of drawing behind the web element 9. It is therefore not cut and the channel 12 running through the web element 10 is only shown with a dotted line. The channel 11 of the web element 9 of the first group runs from a first end 13 to a second end 14 of the web element. The channel 11, 12 can have a cross-sectional area in the shape of a round element. The round element is obtainable from the group of circles, ovals, rounded rectangles or polygons.

The mixer insert and the cladding element 2 according to FIG. 1 are manufactured as a monolithical structure in a casting process. The cladding element 2 consists of a jacket body 51 which contains an inlet stub 52 and a discharge stub 53 for a heat exchange fluid. The jacket body comprises a distribution channel 64 for the distribution of a heat exchange fluid to a plurality of feed channels and a collection channel 65 for the collection of the heat exchange fluid from a plurality of discharge channels. For instance each of a feed channel 54 and a discharge channel 55 are in a fluid connection with the first and second end 13, 14 of the web element. For each of the web elements which contain channels a feed channel 56, 58, 60 is foreseen which supplies the heat exchange fluid to the corresponding channel in the web element and a channel 57, 57, which guides the heat exchange fluid from the channel in the web element to the collection channel 65 of the jacket body 51. In FIG. 1, the web elements 9, 29, 39, 49 are shown in a sectional view, the web elements 10, 20, 30, 40, 50 are positioned in a rear plane of drawing. The channels in these web elements are not visible, therefore they are not designated.

The transition from at least one of the first and second ends 13, 14 of the web element 11 to the corresponding channel 54, 55 in the jacket body 51 of the cladding element 2 is free from gaps. The web elements of the mixer insert 3 as well as the cladding element 2 thus consist of a single piece which is manufactured advantageously by a casting process.

The method for manufacture of a device 1 for the mixing and heat exchange as shown in FIG. 1, which contains a mixer insert 3 and a cladding element 2 is performed in a monolithical structure at least for segments by the casting process. The monolithical structure comprises a first and second group 5, 6 of web elements 9, 10 and a cladding element 2 which is arranged in an angle not equal to zero with respect to the main direction of fluid flow and comprises a cladding element 2 which is arranged in a fixed manner to at least a portion of the web elements. The web elements 9, 10 have channels 11, 12. These channels are passed through in the operating state by a heat exchange fluid, which is not in connection with the flowable medium which flows around the web elements. A mold is formed during the casting process by a wax body, a ceramic shell is applied onto the wax body, thereafter the wax is removed and the ceramic shell is manufactured by a burning process, such that the ceramic shell can be filled with castable material. The castable material is hardened by cooling and the ceramic shell is removed after solidification of the castable material.

To manufacture the web elements 9, 10 and the corresponding channels 11, 12 by the casting process without holes, the transitions from the cladding element 3 to the mixer insert 3 are disposed with rounded portions, what is shown in detail in FIG. 5. FIG. 5 is and enlargement of the region around the second end 14 of the web element 9. All other ends are advantageously provided with similar rounded portions. In FIG. 5 a rounded portion 91 is shown, which forms the transition from an upper edge or an upper edge surface of the web element 9 towards the interior of the jacket body 51 of the cladding element. A rounded portion 94 forms the transition from the lower edge or the lower edge surface of the web element 9 towards the inner side of the jacket body 51 of the cladding element. The transition from channel 44 to channel 11 is realized also by a rounded portion. The convex rounded portion 92 and the oppositely arranged concave rounded portion 93 are shown in a sectional view. Each of the rounded portions 91, 92, 93, 94 can in particular have a radius of at least 0.5 mm.

Any number of groups of web elements can be arranged in a sequence in the direction of fluid flow. In the current embodiment, a plurality of first partial groups 25, 35 are shown. The group 5 has been described as a substitute for the first partial groups 25, 35. The first partial groups 25, 35 are configured in the same way as the group 5 and therefore the description of the group 5 is shown as a substitute for the groups 25, 35. In the same manner a plurality of partial groups 26, 36 are shown next to the second group 6. The second group 6 is described as a substitute for the second partial groups 26, 36 as well. The second partial groups 26, 36 are constituted in the same manner as the second group 6.

Furthermore in FIG. 1 is shown also a first partial group 15 and a second partial group 16, whose web elements don't contain a channel. Therefor a part of the web element doesn't contain a channel. Therefore a portion of the web elements may not contain a channel. In addition the web element 19 extends from the first partial group 15 only from the jacket body 51 to the longitudinal axis 4. The web element 20 of the second partial group 16 also extends only from the jacket body 51 to the longitudinal axis 4. The first and second group planes 17, 18 of the web elements 19, 20 intersect on the longitudinal axis 4. The first partial group 15 and the second partial group 16 from a right handed end of the mixer insert. The right handed end is characterized by an end plane 70, which is a normal plane to the longitudinal axis and rung through the right sided end points of the web elements 19, 20. The end plane constitutes the right end of the mixer insert. On the right side of the end plane 70 a further mixer insert can follow. In particular, the mixer insert can comprise a first group of web elements and a second group of web elements, whereby the first group of web elements is rotated with respect to the first group 5 about an angle of between 80 and 100 degrees with respect to the longitudinal axis and the second group of web elements is rotated about an angle of between 80 and 100 degrees with respect to the longitudinal axis. This further mixer insert is not shown in the drawings.

If the first partial group 15 and the second partial group 16 are missing a gap would result, which would offer less possibilities for a deflection of the flowable medium and consequently would result in a less optimal mixture of the flowable medium.

According to a variant, the partial groups forming the end of the mixer insert can also contain channels to additionally improve the heat exchange. Therefore in FIG. 1 a first partial group 45 and a second partial group 46 are also shown, which comprise web elements 49, 50 containing each a channel 41, 42. The channels 41, 42 of neighboring web elements can be connected such that the heat exchange fluid flows from the feed channel 60 to a discharge channel, which is arranged behind the discharge channel 57 and which is not visible in the graphical representation.

In addition the web element 49 of the first partial group 45 only extends from the jacket body 51 to the longitudinal axis 4. The web element 50 of the second partial group 46 also extends only from the jacket body 51 to the longitudinal axis 4. Both of the first and second group planes of the web elements 49, 50 intersect on the longitudinal axis 4. The first partial group 45 and the second partial group 46 form a left end of the mixer insert in the representation according to FIG. 1. The left end is characterized by an end plane 71, which is a normal plane to the longitudinal axis 4 and runs through the left handed end points of the web elements 49, 50. The end plane forms the left handed end of the mixer insert. On the left side of the end plane 71, a further mixer insert can follow.

That means the group plane 7 of the first group 5 intersects with the second group plane 8 of the second group 6 such, that a common crossing line 75 is formed, which as an intersection point with the longitudinal axis 4 or runs substantially crosswise to the longitudinal axis and/or has minimal distance to the longitudinal axis in a normal plane to the intersection line which contains the longitudinal axis. The web elements have a symmetrical configuration with respect to the intersection plane in this arrangement, such that the mixing in the portion of the mixing space above the longitudinal axis is substantially the same as in the portion of the mixing space below the longitudinal axis.

As described previously, FIG. 1 shows two groups 15, 45, 16, 46 of web elements, which extend substantially to the crossing line 75, such that it is ensured that no gaps result, which don't contain web elements and in which the mixture of the flowable medium doesn't occur in the same manner as in the mixing space 80 disposed with web elements.

According to an embodiment not shown in the drawings the mixer insert could consist only of a first group 5 and a second group 6. Therefore the first group 5 and the second group 6 are considered as substitute for a plurality of similar first and second groups. The amount of pairs of groups in each single case depends on the particular mixing and heat exchange task. That means, if in the following text it is described only a first and second group it can't be concluded that only this particular embodiment is disclosed, in the contrary, embodiments containing a plurality of group pairs, in which each of the group pars consists of a first and second group shall be comprised by this description. For simplicity the description is limited to one of the group pairs, a repetition of the description for any additional further group pairs 25, 35, 26, 36 is omitted.

The channels 11, 12 run inside the web elements 9, 10, such that there exists no connection between the channels inside the web elements and the mixing space 80 which surrounds the web elements.

The first and second group plane are arranged in an angle of 25 to 75 degrees with respect to the longitudinal axis 4. In the current graphical representation the angle lies in the range of 30 to 60 degrees with respect to the longitudinal axis 4, in most cases substantially 45 degrees to the longitudinal axis 4.

The groups arranged in series are arranged advantageously in such a way that they overlap so to offer the maximum active heat exchange surface possible within the volume provided by the cladding element 2. Under overlapping it is intended that at least a portion of the web elements of the first group and a portion of the web elements of a subsequent group and/or a portion of the web elements of a preceding group are arranged in the same tubular section when viewed in the main direction of fluid flow. The projection of the length of a web element onto the longitudinal axis results in a length L1 and the projection of the overlapping portion of the web elements of the neighboring group onto the longitudinal axis results in a length L2, whereby L2 is smaller than L1 and L2 is greater than zero. The relevant tubular section is thereby defined such that it has a length L1, which forms the enveloping volume of the centrally arranged web element 9. The enveloping volume is an enveloping cylinder if the cladding element is cylindrical with a circular cross-section and it is an enveloping cuboid for a cladding element of a rectangular or polygonal cross-section.

FIG. 2 shows a three dimensional sectional view of the device according to FIG. 1. The parts which are the same as in FIG. 1 are designated in the same manner in FIG. 2 and are not described anymore as they have already been described in connection with FIG. 1. FIG. 2 shows the web elements 20, 21, 22, 23, 24 belonging to group 15.

FIG. 3 shows a view of a mixer insert for the device according to FIG. 1. The mixer insert 3 differs from FIG. 1 only inasmuch as the groups 45, 46 don't contain channels.

FIG. 4 shows a three dimensional sectional view of a device according to a second embodiment, in which a first mixer insert 3 and a second mixer insert 103 are arranged in a first cladding element 2 and a second cladding element 102 in series. The first cladding element 2 and the first mixer insert 3 are rotated with respect to the second cladding element 102 and the second mixer insert 103 about an angle of 90 degrees. The feed of heat exchange fluid to the mixing space is realized by a first feed stub 52 and the discharge of the heat exchange fluid is realized by a first discharge stub 53. As the second cladding element is rotated as a whole about 90 degrees to the first cladding element 2, the second feed stub 152 and the discharge stub 153 are rotated about 90 degrees.

FIG. 6 shows a two dimensional sectional view of a third embodiment of a device according to the invention. The device 1 consists of a cladding element 2 and a mixer insert 3 which have a common longitudinal axis 4.

A first group 5 and a second group 6 of web elements extend along the longitudinal axis 4. The groups are arranged in a first group plane 7 and a second group plane 8. A web element 9 of the first group is shown in section as well as a web element 10 of the second group. The first and second group planes run as a difference to the previous embodiments substantially parallel to each other. The web elements, which would end in the end plane 71 can be connected to a collection element 155. In particular the collection element 155 can have a collection channel 157. The web elements which initiate in the end plane 70 can be connected to a distribution element 156. The distribution element 156 can contain a distribution channel 158.

The heat exchange fluid is supplied to a distribution channel 64 in the cladding element 2 via a supply stub. The heat exchange fluid is directed from the distribution channel 64 via the supply channels 54, 56, 58, 60, 62, 154 and also via the supply channel 158 into the channels of the web elements.

The heat exchange fluid reaches the collection channel 157 and the discharge channels 57, 59, 61, 63, 159, 161, 163, 165, 167 after flowing through the channels in the web elements. The heat exchange fluid is directed from the discharge channels into the collection channel 65 and to the discharge stub 53. The flowable medium flows around the web elements into the mixing space 80.

FIG. 7 shows a two dimensional sectional view of a fourth embodiment of the device according to the invention. This sectional view shows, that the web elements can be arranged in any angle. In particular a first web element 9 of a first group 5 and a second web element 10 of a second group 6 are shown. A plurality of similar or different web elements 9 can be arranged along the first group plane 7. The web elements of this group which are positioned behind the web element 9 are not visible in this graphic representation. The angle which is enclosed between the cutting line shown in the plane of the drawing of the first group plane 7 and the longitudinal axis 4 differs from the angle which is enclosed by the shown cutting line of the second group plane with the longitudinal axis 4. The widths of the web elements of the first group 5 can differ from the widths of the web elements of the second group 6.

Neighboring groups can have group planes either arranged in parallel or in an angular position relative to the longitudinal axis 4. A partial group 15 is shown whose group plane 17 runs parallel to the group plane 8. A further partial group 25 is shown in a variant, whose group plane 27 is not parallel to the group plane 8, but encloses a smaller angle with the longitudinal axis 4.

As a further variant it is shown that more than two groups can intersect and can be connected by common connection elements. The group 5 can be connected to the partial group 15 and the partial group 35 by common connection elements. The connection elements are not shown, they can be configured for instance as lateral web elements which are arranged normally to the plane of drawing and connect group 5 and partial group 15 in the area of the crossing point. In the same way the partial group 15 can be connected to the partial group 35.

As a further variant a partial group 16 is shown. The partial group 16 contains a web element 20 which has two web element portions 31, 32. The two web element portions 31, 32 enclose an angle with respect to each other. It would be also possible that the first web element portion and the second web element portion are connected by a curved portion, whereby this variant is not shown in the drawings.

FIG. 8 shows a view of a device according to a fifth embodiment. The device 1 consists of a mixer insert 3 and a cladding element 2. The mixer insert 3 is mounted inside the cladding element 2 having a rectangular cross-section. Other cross-sections are possible, for instance circular cross-sections. The current representation shows a first group 5 and a second group 6 of web elements. The web elements 9, 19 of the first group 5 are the same and are arranged parallel to each other. The web elements 10, 20 of the second group 6 are the same and are arranged parallel to each other. The web elements 9, 19 enclose an angle with the web elements 10, 20. That means according to this variant, neighboring web elements belong at least partially to the same group. Downstream of the first group 5 and the second group 6, a first partial group 15 and second partial group 16 are arranged. The web elements of the partial groups 15, 16 are rotated about the longitudinal axis 5 about an angle of 90 degrees with respect to the web elements of the first and second groups 5, 6. The mixer insert 3 contains a further partial group 25 and a further partial group 26. These two partial groups 25, 26 are mirrored in relation to the groups 5, 6 about a normal plane of the longitudinal axis 4.

In FIG. 8 also channels are shown which run inside the web elements. The channel 11 of the web element 9 has an oval or circular cross-section. The channels can also have other cross-sectional areas. A multitude of different cross-sectional areas can be used with the casting process. The web element 29 shows for instance a channel 31 with a rectangular cross-section. Triangular or multiangular cross-sectional areas can be realized in the same manner.

The cladding element 3 is shown only in portion. The cladding element 2 includes a feed stub 52 and a distribution channel 64, which is shown only partially. The distribution channel 64 is in connection with a portion of the channels in the web elements. By means of the distribution channel 64 a heat exchange fluid which is supplied by the feed stub can be distributed onto the channels of the web elements. The ends of the web elements arranged opposite to the distribution channel lead into the collection channel. The heat exchange fluid flows from the collection channel into the discharge stub and can leave the device 1 via this discharge stub.

FIG. 9 shows a first variant of an extrusion arrangement with a mixer insert according to any of the preceding embodiments. This extrusion arrangement consists of a first extruder 201, a second extruder 211, a transfer line connecting the first extruder 201 with the second extruder 211 and a die element 240, through which the polymer melt leaves the extrusion arrangement. A method for manufacturing a foam of low density can be performed in this extrusion arrangement. A polymer is melted in the first extruder 201 to a polymer melt, a blowing agent is added to the polymer melt by a blowing agent supply device 204, then the blowing agent is dissolved in the melt by mixing and dispersion processes in the first extruder 201 and/or in a static mixing path formed by a static mixer 220 or a transfer conduit 215 between the first and a second extruder 211 and/or in the second extruder 211, then the melt charged with blowing agent is cooled in the second extruder 211, then the melt is guided through a static mixer 230, whereby the static mixer has a mixer insert 3, by which the temperature of the melt is homogenized over the entire cross-section and which is cooled or heated contemporaneously to reach the exact melt temperature. Thereafter the temperature stabilized cooled melt is discharged by a die element 240, 250.

According to an embodiment the mixer insert contains inserts which enter into the melt and by which the melt can be cooled or heated.

The temperature of the melt can be homogenized advantageously by the mixer insert 3, such that the lowest and the highest temperature differ less than 5 degrees Celsius in the melt cross-section downstream of the mixer insert. In particular the temperature can be homogenized by the mixer insert 3 such that the lowest and the highest temperature in the melt cross-section differ less than 3 degrees Celsius, particular advantageously differ less than 1.5 degrees Celsius.

According to an embodiment, the mixer insert 3 comprises a first group 5 of web elements and a second group 6 of web elements, whereby the first group 5 of web elements extends along a common first group plane 7 and the second group 6 of web elements extends along a second common group plane 8. In particular at least a portion of the web elements 9, 10 can contain channels 11, 12, whereby the channels extend from a first end 13 of the web element 11 to a second end 14 of the web element 11, whereby the cladding element 2 contains each a corresponding channel which is in fluidic connection with the first end 13 and the second end 14 of the web element.

Advantageously the melt temperature can be controlled after the mixer insert by a coolable or heatable mixer insert 3. Under melt temperature after the melt insert is intended the temperature in the melt after having left the static mixer 230 for instance shortly before the die element or inside the die element.

The die element downstream of the mixer insert can be either a die 240, as shown in FIG. 11 or as a granulator 250 as shown in FIG. 10. Subsequent to the die element, a cooling device 260 can be foreseen in which the extrudate is cooled until its solidification.

The blowing agent can be added by a blowing agent supply device 204 and or through the polymer raw material supply into the feed hopper 205, which is arranged at the first extruder 201. In addition or alternatively thereto the blowing agent can be added by a blowing agent supply device 214, which is arranged at the second extruder, what is shown in FIG. 10 or FIG. 11 or by a supply device which is arranged in the transfer conduit 215. Thus the blowing agent can be added to the melt in at least one of the first or second extruders.

FIG. 10 shows a second variant of an extrusion arrangement with a mixer insert according to one of the preceding embodiments in which the die element is followed by a granulator 250. In the granulator, a polymer melt leaving the die element is milled by cutting elements. Before, during or after the milling process, the melt is hardened by cooling. The melt is guide for instance through a cooling medium bath.

FIG. 11 shows a third variant of an extrusion arrangement with a mixer insert 3 according to any of the previous embodiments. This extrusion arrangement consists of a first extruder 201, a second extruder 211, a static mixing path, which connects the first extruder 201 with the second extruder 211 and a die element 240 through which the melted polymer melt leaves the extrusion arrangement. The static mixing path comprises the static mixer 220. Instead of a static mixer or as an additional element, a heat exchanger can be foreseen. It is also possible to foresee apparatus, in which the functions of a mixer and a heat exchanger are combined. A method for manufacturing a foam of low density can be performed in this extrusion arrangement. A polymer is melted in the first extruder 201 to a polymer melt, a blowing agent is added to the polymer melt by a blowing agent supply device 204, then the blowing agent is dissolved in the melt by mixing and dispersion processes in the first extruder 201 and/or in a static mixing path formed by a static mixer 220 and in the second extruder 211, and optionally cooled by a heat exchanger, then the melt charged with blowing agent is cooled in the second extruder 211. Subsequently the melt is guided through a static mixer 230, whereby the static mixer has a mixer insert 3, by which the temperature of the melt is homogenized over the entire cross-section and which can be cooled or heated contemporaneously to reach the exact melt temperature. Thereafter the temperature stabilized cooled melt is discharged by a die 240.

In FIG. 12 a variant of FIG. 11 is shown which shows an additional blowing agent supply device 224 or other additives in the transfer conduit 215. The blowing agent supply device can be used together with the supply devices 104 and 214, optionally the addition of blowing agents or additives can be omitted in at most two of the three supply devices 204, 214, 224. That means, depending on the composition of the polymer melt and/or the desired mechanical properties one or more supply devices can be used.

The invention is not limited to the embodiments of mixer inserts mentioned above. The web elements can differ in their amount and dimensions. Instead of web elements, tubular elements or substantially two-dimensional elements can be foreseen, for instance wing elements. Furthermore, the number of channels in the web element can differ depending on the required heat supply for the heat exchange. The angles of inclination which the groups enclose with the longitudinal axis can vary depending upon the application. Furthermore more than two mixer inserts can be arranged in series.

1. A method for manufacturing low density foams in which a polymeric material is melted in a first extruder (201) to a polymer melt, the polymer melt is fed to a second extruder (211) a blowing agent is added to the polymer melt, such that a melt containing the blowing agent is obtained, thereafter the melt containing the blowing agent is cooled in the second extruder (211), thereafter the melt is directed through a static mixer after leaving the second extruder (211), whereby the static mixer is disposed with a mixer insert (3), whereby the mixer insert (3) has insert elements, which engage with the melt, such that the temperature of the melt is homogenized over the entire cross-section of the mixer insert, whereby the static mixer can be cooled and/or heated to obtain a temperature stabilized cooled melt, whereby the temperature stabilized cooled melt is discharged subsequently through a die element (240, 250).

2. The method according to claim 1, whereby at least one of the insert elements contains a channel for the passage of a heat exchange fluid.

3. The method according to claim 2, whereby the entire melt is mixed by the insert elements continuously in the mixer insert whereby the melt flow is not divided into partial flows.

4. The method according to claim 1, whereby the blowing agent in the melt is dissolved by mixing and dispersion processes in the first extruder (201) and/or in a static mixer (230) and/or in a transfer conduit (215) between the first and the second extruder (211) and/or in the second extruder (211).

5. The method according to claim 1, whereby the melt is directed through a static mixer (220) after leaving the first extruder (201) and before the melt enters the second extruder (211).

6. The method according to claim 1, whereby a temperature equalization is obtained between the first and second extruder, whereby the melt is directed through a mass or heat exchange device, from the group of at least one of a dynamic mixer, a static mixer, a heat exchanger or a transfer conduit, which can be configured as a heatable or coolable tubular element or by a combination of at least of two of said mass transfer or heat exchange devices.

7. The method according to claim 1, whereby downstream of the mixer insert (3) the temperature between the lowest and the highest temperature in the melt cross-section after the mixer insert differs less than 5 degrees Celsius from each other.

8. The method according to claim 2, whereby the insert elements comprise tubular, web-shaped or substantially two-dimensional, or wing-shaped web elements.

9. The method according to claim 8 wherein a group is formed by at least a portion of the web elements, whereby the web elements each comprise a central axis, whereby the central axes of the web elements which belong to the group enclose a constant angle to the central axis of the mixer insert.

10. The method according to claim 1, whereby the mixer insert (3) comprises a first group (5) of web elements and a second group (6) of web elements, whereby the first group (5) of web elements extends along a first common group plane (7) and the second group (6) of web elements extends along a second common group plane (8).

11. The method according to claim 10, whereby the group plane (7) is formed by the central axes of the web elements or the tubular elements belonging to the respective group.

12. The method according to claim 10, whereby at least a portion of the web elements (9, 10) contains channels (11, 12) whereby the channels extend from a first end (13) of the web element (11) to the second end (14) of the web element (11), whereby the cladding element (2) contains each a corresponding channel which is in fluidic connection with the first end (13) and the second end (14) of the web element.

13. The method according to claim 1, whereby the melt temperature downstream of the mixer insert is controlled by the heatable or coolable mixer insert (3).

14. The method according to claim 1, whereby the temperature stabilized cooled melt flows through a die (240) and/or a granulator (250) downstream of the mixer insert.

15. The method according to claim 1, whereby the blowing agent is added by a blowing agent supply device (204, 214, 224) in at least one of the first and second extruder or the transfer conduit (215).
